(19) United States
(12) Patent Application Publication
(10) Pub. No.: US 2009/0055206 A1
(43) Pub. Date: Feb. 26, 2009

(54) Method and system for performing address resolution processing

(75) Inventor: Wayne Orbke, Germantown, TN (US)

Correspondence Address: MCDERMOTT WILL & EMERY LLP, 600 13TH STREET, N.W., WASHINGTON, DC, 20005-3096, US

(73) Assignee: BOWE BELL + HOWELL COMPANY

(21) Appl. No.: 11/892,581

(22) Filed: Aug. 24, 2007

(51) Int. Cl. G06Q 10/00

(52) U.S. Cl. 705/1

(57) ABSTRACT

A process for resolving addresses to obtain mailing discounts from a postal authority by using an address resolver, including at least one database that is not approved by the postal authority, to resolve a first type of failure, and using a point resolver to resolve a second type of failure.

### TECHNICAL FIELD

The subject matter discussed herein relates to a method and system for resolving address quality issues that impede the effectiveness of mail piece delivery.

### BACKGROUND

The prior art cost-effective, consistent, and timely delivery of mail pieces depends on correct address usage. An accurate address contains only address data elements (e.g., primary address numbers, Zip Codes, street names) that are complete and correct. When a mailer sends mail pieces with accurate addresses, they are supporting the mutual goal of most postal authorities, such as the USPS® (United States Postal Service®) and mailers to achieve the lowest combined cost for providing and receiving mail service. They also ensure the mail is compatible with the USPS automation process and associated equipment, therefore putting it on the fast track for delivery. However, when a mail piece is missing address data elements or contains incorrect address data elements, it requires additional handling by USPS, including manual processing, which can impede the automation process (i.e., reduce work sharing discounts), delay delivery or even make delivery impossible.

To ensure application of proper address data elements upon mail pieces, mailers employ various tools including address cleansing and correction software, list generation software, address databases and the like. In general, these tools fall into the category of address quality tools, and must be compliant with recognized postal authority address quality processing rules and standards. With respect to the USPS, such standards include the Coding Accuracy Support System (CASS), Delivery Point Verification (DPV), Presort Accuracy Validation and Evaluation (PAVE) and National Change of Address (NCOA) processing. Vendors that specialize in providing address quality tools and services must be formally registered and further certified with the postal authority as being in compliance with such standards. Useful as these tools may be, they are still limited in their ability to resolve and process many occurrences of improper address elements as they occur. This limitation is mainly a result of the strict standards imposed by the address quality processing rules themselves. For example, certain of the USPS address quality processing rules restrict the performance of phonetic and string comparisons by the address quality software to very conservative levels. Still further, the rules may even restrict the geographic range that an address may potentially be searched in by the software, such that the searches may be performed in only designated ZIP Codes. Suffice to say, the very conventions that enable compliance with postal authority standards may impede the ability of a designated software tool to resolve address issues and/or errors accordingly.

### SUMMARY

In response to the challenges described above, the exemplary technique and system presented herein relates to a process for resolving addresses to obtain mailing discounts from a postal authority by using an address resolver, including at least one database that is not approved by the postal authority, to resolve a first type of failure, and using a point resolver to resolve a second type of failure.

In one example, input addresses may be received, and one or more of the received input addresses may be resolved an address resolver. The address resolver may comprise one or more address resolution elements for rendering an address capable of certification. At least one of the address resolution elements is not be approved by a postal authority for certification. Further, the resolved address may be selection processed, and the selection processor may comprise a certifier approved by a postal authority for certification.

In a second example, input addresses may be received, and one or more of the received input addresses may be resolved using a point resolver. The point resolver may comprise one or more point resolution elements for rendering an address capable of verification. At least one of the point resolution elements is not approved by a postal authority for verification. Further, point resolved address may be verified using a verifier approved by a postal authority for verification.

In a third example, address data may be resolved using one or more resources. The one or more resources include at least: a first data source comprising address data not approved by a postal authority; a second data source comprising address data approved by a postal authority; and one or more software processing modules for processing the first and second data source, said first data source being usable by at least one of the software processing modules in association with the address data input for rendering address data output capable of meeting postal authority standards, said second data source being usable by at least one of the software processing modules for determining whether or not the address data output is sufficient to meet postal authority standards.

In a fourth example, address quality processing errors may be resolved by receiving an initial address, determining that a specific numeric portion of an address element of the received initial address is within a certifiable range in accordance with certification data from a postal mailing authority; determining that the initial address does not correspond to a verified delivery point address according to verification data from the postal mailing authority; performing transposition logic processing on the numeric portion, the transposition logic being performed on the basis of the certifiable range in order to generate at least an output address; and determining whether the output address corresponds to a verified delivery point address.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exemplary system architecture for performing address quality processing.

FIG. 2 is an exemplary flowchart depicting the high level process for performing address quality processing.

FIG. 3 is an exemplary flowchart depicting an address quality processor comprising an address resolver and a point resolver.

FIG. 4 illustrates an exemplary series selection processor.

FIG. 5 illustrates an exemplary parallel selection processor.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

Address is defined as data including one or more of: recipient name, street number, street name, street extension, apartment number, suite number, building name, city, and state.

State is defined as an administrative region larger than a city. For example: Texas of the United States, or District of Columbia of the United States, or a territory, or a province, or a canton.

Certifying is defined as testing whether an address is a “valid postal authority address.” A valid postal authority address is an address that is qualified for usage to obtain postal authority work sharing discounts based on compliance with postal authority standards. In some instances, a certified address may be a valid delivery point address. Specifically, a valid postal authority address has, at a minimum, the following five data elements: (1) a street number, (2) a street name, (3) a street extension, (4) a city, and (5) a state. Of course, the data elements may differ depending upon the postal authority, state, or jurisdiction in question. Generally, for certification purposes the street number is only examined with respect to a given range. For example, a valid postal authority address will have a street number within a certain range associated with: the street name, the street extension, the city, and the state combined (e.g. 100-200 Main Street). In the United States, the United States Postal Service (USPS) presently uses CASS as a certification standard, wherein a CASS address matching processing engine is used as a certifier. The type of certified employed may too vary depending upon the postal authority, state, or jurisdiction in question. Optionally, certifying may also return the certain range associated with the other data for screening or for limiting the results from a street number transposer.

Verifying is defined as testing whether an address is a “valid delivery point address.” A valid delivery point address is an address which is recognized and confirmed by a postal authority as a physical site for mail delivery as addressed. A valid delivery point address may include all of the data elements of a valid postal authority address: (1) a street number, (2) a street name, (3) a street extension, (4) a city, and (5) a state. A valid delivery point address may also include other data such as a name of a person or business, an apartment number, a suite number, or a building name. Of course, the data elements may differ depending upon the postal authority, state, or jurisdiction in question. In the United States, the USPS presently uses DPV as a verification standard, wherein a DPV address matching processing engine is used as a verifier.

Address resolving is defined as the execution of the one or more processes associated with an address resolver. In particular, address resolving may entail the usage of one or more address resolution elements (e.g., tools and data sources) not approved by a postal authority for rendering an address capable of certification.

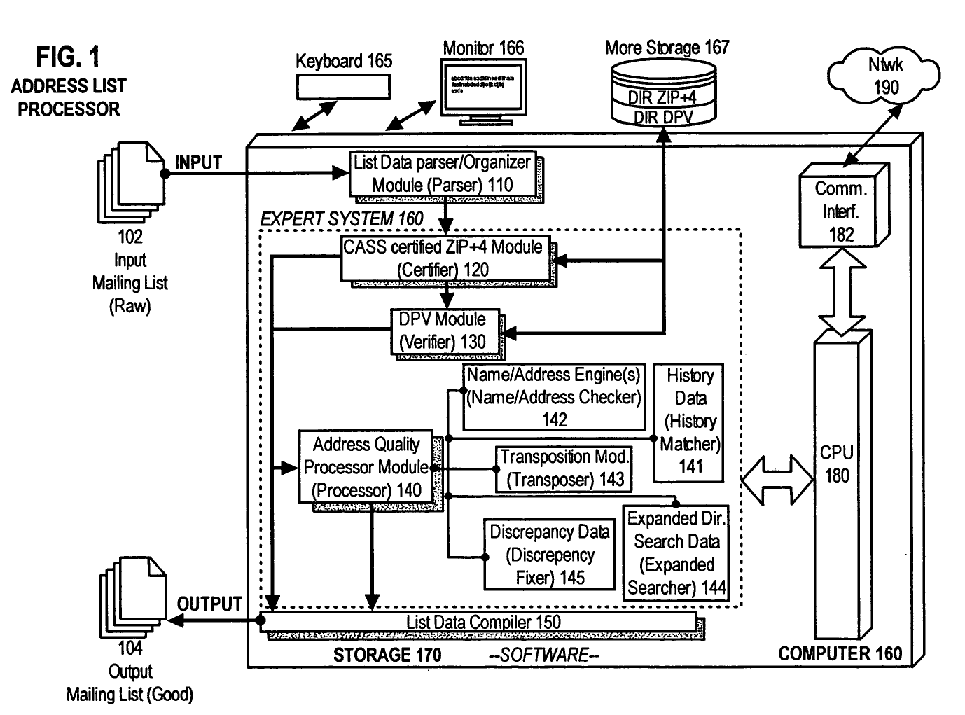

FIG. 1 is an exemplary system architecture for performing address quality processing. FIG. 1 illustrates various typical hardware including: computer 160, storage 170, CPU (central processing unit) 180, communication interface 182, network 190, keyboard 165, monitor 166, and more storage 167. While depicted peripherally in the exemplary figure, those skilled in the art will recognize that devices such as keyboard 165 and monitor 166 may operate peripherally or integrally to the computer 160.

Storage 170 and more storage 167 include software modules and databases such as: list data parser/organizer (Parser) 110, CASS certified ZIP+4 (Certifier) 120, DPV (Verifier), DIR ZIP+4 (directory for ZIP+4) and DIR DPV (directory for DPV), Address Quality Processor Module (Processor) 140, and List Data Compiler 150. The Address Quality Module (Processor) 140 includes or calls other modules such as: History Data (History Matcher 141), Name/Address Engine(s) (Name/Address Checker) 142, Transposition Module (Transposer) 143, Expanded Directory Search Data (Expanded Searcher) 144. Expert System 160 includes: Certifier 120, Verifier 130, and Processor 140.

An input mailing list (raw or unverified addresses) 102 is input into Parser 110 for parsing addresses into one or more address data elements. Parser 110 transmits parsed addresses into Expert System 160. Expert System 160 transmits verified addresses to List Data Compiler 150. List Data Compiler outputs an Output Mailing List 104 of verified or good addresses.

Input address data may be derived from a mailing list imported from a local or network accessible storage medium. Typically, the Input Mailing List 102 contains a plurality of address data corresponding to a plurality of respective recipients. Said address data is generally sufficient to indicate one or more elements, such as shown below:
Recipient Name and/or Entity Name
Recipient's address—Line 1—(e.g., building name)
Recipient's address—Line 2—(e.g., street name and number)
Recipient's address—Line 3—(e.g., P.O. Box/apartment number/suite number) City, State Zip

Of course, other address data elements besides those shown may also be employed. Likewise, the mailing list need not be formatted as shown above. Indeed, the above shown address data elements may be oriented within the data file representative of the mailing list in a single line fashion, where each of the respective fields or address data element types are separated by delimiters. Furthermore, the address data may be the entire mailing list, or an individual address entry respective to a single recipient. Any means by which the Parser 110 may acquire the necessary input mailing list 102 for performing address quality processing and resolution is within the scope of the examples presented herein.

In addition, the list data parser/organizer module 110 may arrange the address data input 128 in a specified order, such as that necessary for maximizing the occurrences of nine digit Zip Code (ZIP+4 coding) lookups as commonly performed in the art or in a pre-sort order. The input mailing list 102 may also optionally be assigned a control number in cases where address element correction (AEC) is desired as a means of address quality processing. More about AEC will be discussed below.

Once parsed, the address data may be further processed by one or more executable modules for performing address quality processing respective to postal authority conventions. In the example of FIG. 1, this includes a Certifier 120 and Verifier 130. As presented herein, the Certifier 120 and Verifier 130 will be generally discussed from the perspective of the USPS. However, those skilled in the art will recognize that the Certifier 120 and Verifier 130 as used herein may be employed by any postal authority accordingly. In particular, the Certifier 120 analyzes the address data elements representative of a given address to determine if it can be matched up (looked up) against range-based USPS certified ZIP+4 data 124 (e.g., in accord with CASS). A successful match enables the Certifier 120 to return the corresponding ZIP+4 code, deeming said address as certified. An unsuccessful match results in the CASS processing module returning no ZIP+4 code, which deems the processed address as invalid or not certified. An invalid CASS determination prevents an address, when applied to a mail piece, from being DPV verified and qualifying for work sharing discounts afforded by the USPS.

Operating in association with the CASS Certifier 120 is the DPV Verifier 130, which identifies whether an address provided as input is currently represented in the USPS® delivery point database as an actual deliverable location. In the context of the example presented herein, the DPV Verifier 130 determines whether an address suitable for returning a ZIP+4 code is actually deliverable. Hence, it is possible for an address to be sufficient to return a ZIP+4 code yet still be undeliverable as designated. At present, where the postal authority is the USPS, an address that is certified (i.e., is sufficient to return a ZIP+4 code) yet determined to be undeliverable as addressed (i.e., is not sufficient to meet DPV requirements) would violate CASS Cycle L regulations; therefore not meeting postal authority address quality processing standards (i.e., USPS CASS Cycle L compliance).

As an example, consider a scenario wherein a mail piece is marked with a street address sufficient enough to return a ZIP+4 code, but indicates a non-existent or incorrect primary address number, suite number or apartment number. While a ZIP+4 code may be returned with such an address as marked, the lack of subsequent DPV verification would render the address input as not meeting postal authority standards (i.e., not CASS Cycle L compliant). Consequently, the DPV Verifier 130 would return an invalid DPV notification message such as to the user (perhaps to a user Monitor 166) and no ZIP+4 code may be returned from the Verifier 130. On the other hand, when an address is verified by Verifier 130, a notification is provided that the address input meets postal authority address quality standards (e.g., CASS Cycle L requirements).

Of course, those skilled in the art will recognize that various other postal authority address quality standards other than those referenced above may require a means of resolution, verification, certification and/or confirmation. The scope of the example is not limited to the address quality standards discussed above, as other standards may too apply in future applications. While the discussion herein is presented from the perspective of the CASS or DPV postal authority standards, it will be apparent to the skilled practitioner that other standards required by a postal authority may be applied as needed. For example, other address quality processing standards benefiting from the exemplary method and system presented herein may include, but is not limited to the Locatable Address Conversion System (LACSlink), SUITElink, the National Change of Address (NCOA) standard, etc. Likewise, other processing modules may be optionally employed in addition to or instead of exemplary modules Certifier 120 and Verifier 130 to meet any extended needs. Those skilled in the art will recognize that various implementations of processing modules—i.e., CASS and DPV—are well known in the art today for enabling the processing of address data in accord with postal authority conventions.

An address quality processor module (Processor) 140 is also provided for further processing of the address data when required (when certification has failed, or verification has failed). Particularly, the Processor 140 executes logic for correcting or resolving addresses that do not return a favorable result when processed by conventional procedures or prior art. The Processor 140 executes various logical operations and procedures respective to the address data input 128, some of which are performed by a plurality of processing modules 141-145; the execution of said modules being useful for enabling address quality processing and analysis outside of the constraints or limitations of conventional modules. Certifier 120 is restricted to address searches performed within areas defined by USPS finance number groupings of 5 digit ZIP Codes. As such, the geographic areas that an input address 102 may potentially be found in is reduced—consequently reducing the likelihood of the corresponding ZIP+4 code being returned. Hence, to address such issues, the address resolution module calls upon or operates in connection with, but not limited to, the modules 141-144, described in detail below.

History Data (History Matcher) 141—This data record maintains names and/or address data provided as input against a record of previously corrected addresses and/or names processed by the Processor 140. In other words, if a previous solution (e.g., certified or verified address) has been found for a previous problem (an address that failed certification or failed verification), then History Matcher 141 remembers the problem and the solution. Each time the Processor 140 successfully “repairs” an input address, a record of the original input address that required correction and the corrected version of said name and/or address input is added to the history data file inside of or associated with the History Matcher 141. The History Matcher 141 may subsequently be used by the Processor 140 to provide “quick hit” type of corrections when duplicate versions of the original input address are submitted for processing by the Processor 140. All solution addresses contained within the history data file of History Matcher 141 are DPV verified. Those skilled in the art will recognize that History Matching is a preferred initial means of address quality processing so as to avoid processing redundancy, as well as increase overall processing efficiency.

Name/Address Matching Engine(s) (Name/Address Checker) 142—This module analyzes names and/or addresses provided as input against one or more commercial and/or postal authority compliant name/address databases. By postal authority compliant, it is meant that generally, the address data sources relied upon by the address matching engines themselves conform to a particular postal convention—i.e., the addresses stored therein are certified or verified. One or more name/address matching engines (AMEs) may be employed to increase the likelihood of a name/address match for enabling correction of those addresses that return an unfavorable result (e.g., Certifier 120 failure or Verifier 130 failure).

Conventional address matching techniques for address quality processing rely solely upon analysis of specific address data elements (e.g., delivery address, city, state, and ZIP Code) against postal authority certified address data.

However, for the exemplary techniques presented herein, one or more name/address matching engines (Name/Address Checker 142) may be employed, which further access one or more associated address and name databases available from the commercial sector (e.g., Experian, AltaVista, Switchboard, BigBook, Lexis-Nexis) which are not certified or verified by the postal authority. Additionally databases certified or verified by the postal authority (e.g., USPS NCOA directory) may also be utilized.

Search algorithms for the one or more address matching engines may begin with global searches to identify potential candidates in broad areas associated with both the address data element representative of the name and the address of the input address needing resolution. For example, the search may be initiated by searching the address data element input (e.g., that which is to be corrected) against all records within a 3 digit ZIP area that have the same first name and surname characters as the address data element input. This results in a broad initial pool of return matches from which to identify the best candidate using all reasonable permutations of the name associated with the address record as well as segments of the address itself. From this, best candidates/matches may be determined via comparison to the original name and address, in addition to scoring of said candidates/matches with confidence levels based on similarity and date of information. Confidence level scoring will determine selection or rejection of said candidate/match as a result of this process. The candidate yielding the highest score is returned for further processing in accord with the address resolution modules processing logic. This may include the return result being conveyed via the user interface, or via a separate list, and if approved (e.g., explicitly by the user, or automatically by being deemed the best match), then utilized for correction purposes.

Additionally, a name/address database such as Experian® may provide multiple matches. For example, the Experian database may indicate several possible addresses associated with a name such as Lewis Latimer, some or which may be more current than others, or more closely resemble the input address under analysis. In this fashion, a matched or proposed or resolved address for Lewis Latimer may be obtained through the name/address database, and the address may meet the postal authority requirements.

Transposition Module (Transposer) 143—This module corrects primary address numbers provided as address input 128 that, due to errors, cannot be certified or verified (e.g., DPV verification) using postal authority certified configurations or tools. Also, this module may also correct street names provided as address data input 128 that, due to errors, cannot be verified (e.g., ZIP+4 code returned) using postal authority certified configuration or tools.

Transposer 143 may utilize ranges from the ZIP+4 database in More Storage 167 as a guide to determine the problem with a primary address number that failed DPV. Repair or correction of invalid primary address numbers includes executable routines for, but is not limited to, transposition routines, double/triple digit removal, addition or removal of leading or trailing alpha characters, etc. For example, a primary number 123 may be transposed to yield: 132, 213, 321, etc. If multiple potential fixes (candidates) are identified via this process—meaning the candidates are capable of being DPV confirmed respective to the ZIP+4 range—then selection of a final candidate is based on positional similarity to the original number input. For example, consider an address input within a given ZIP+4 range having a primary number of 123. If primary address number 132 and 321 are DPV confirmed within this particular range, then 132 would be selected based on its positional similarity of the leftmost digit (1), which is less likely to be accidentally transposed than the rightmost two digits. Of course, those skilled in the art will recognize that other transposition logic techniques may be employed without limiting the scope of the examples presented herein. This type of street number transposition may be performed by a specialized Primary Number Transposer.

Transposer 143 may also perform other correction techniques to resolve errors that may occur within street names. For example, a street improperly spelled ‘Knight Ave.” may need be corrected via removal of one or more alpha characters to reveal “Night Ave.” As before, the ZIP+4 range may be used as a guide to pinpoint street names within range most likely to be matches. Additionally, various street name extensions may be considered. For example, “Circle” instead of “Court.” A street name such as “Devonshire” may be matched against similar street names such as: Devenshire, Devonshirt, Devons, and so forth. This type of name correction may be performed by a specialized Primary Number Transposer.

Additionally, Transposer 143 may consider secondary numbers such as apartment numbers or suite numbers. Secondary number logic may be similar to the primary number logic described above. Transposer 143 may comprise distinct submodules for a) primary number transposing, and b) for street name transposing, and for c) secondary number transposing. Alternatively, a single broad module may serve all these functions.

Discrepancy Data (Discrepancy Fixer) 145—This data record maintains a list of commonly misinterpreted alphanumeric characters that may be specified within an input address. When a given input address fails certification or verification, then the Discrepancy Fixer 145 may be used to identify commonly misinterpreted alphanumeric characters. In this way, the erroneous address data elements may be identified by the Discrepancy Fixer and replaced with corrected data. Examples of common discrepancies that may occur include, but are not limited to: number ‘1’ being mistaken for alpha character ‘I’, ‘0’ being mistaken for ‘O’ and the ampersand (&) being mistaken for number ‘8’. In addition, Discrepancy Fixer 145 may also designate erroneous state abbreviations, erroneous shorthand designations (e.g., ‘HIGHWAY’ being indicated as ‘HY’ instead of the commonly used ‘HWY’), etc. Generally, the Processor 140 will seek such discrepancy data in order to quickly and efficiently resolve the primary address number issue to obtain a DPV confirmation. Those skilled in the art will recognize that processing of this nature may be a preferred initial means of address quality processing so as to avoid processing redundancy as well as increase overall processing efficiency.

Expanded Directory Search Data (Expanded Searcher) 144—This module employs one or more cascaded address matching engines having access to address and/or name data that does not necessarily conform to postal authority certification requirements. The term “cascaded” means that the engines may be used in parallel or in sequentially, as will be discussed in detail later in the context of a selector.

The address matching engines (AMEs) are capable of performing data exchange, ultimately to return a certifiable ZIP+4 coded match. The AMEs would access non-CASS certified data sources—i.e., Google maps, Whitepages.com—so as to not limit the scope of the address search capability respective to CASS constraints (e.g., specific zip search limitation).

USPS CASS certification rules restrict the areas that an address may potentially be found in. These search areas are generally based on USPS finance number groupings of 5 digit ZIP Codes.

Commercially available address and/or name data sources (e.g., non-CASS based) are cross referenced against USPS CASS based address data, such that the full scope of a respective input address may be ascertained. For example, consider the following input address, which indicates a 5 digit ZIP Code designation that does not correspond to the city indicated:
Kemet Builders Inc.
1333 N. Tuskegee
Cary, Ill. 60014

If only Certifier 120 operated on the above input address, then the result would be a failed certification and no ZIP+4 code would be returned. The actual ZIP+4 designation for the designated address in Cary, Ill. is 60013-0685, but this information may not be provided by Certifier 120. However, in accord with the exemplary techniques presented, this address data would provide a geographic/area/ZIP Code point of reference from which to cross reference additional data sources accessible by one or more cascaded AMEs. The address input sets the initial proximity or parameters of the search, while the cascaded AMEs (accessing different data sources) would maximize the possible number of related correction candidates. Hence, the AMEs may return ZIP Code designation candidates for other cities within a given proximity to Cary, Ill. or ZIP Code 60014 (e.g., Crystal Lake, Ill., Deerfield, Ill.). Further cross referencing could be performed on the basis of the provided primary address number and street name to determine which of the possible alternate city candidates is the more likely choice. By cross referencing in this manner, the Processor 140 is able to search for corrective opportunities on the basis of geographic relationships, and not just within the confines of the indicated 5 digit ZIP Code. Also, given a selection of AMEs to choose from, but a single point of reference, the address resolution module may pick and choose which AMEs to cascade and rely upon based on the specific data to be analyzed at the moment (e.g., use Cary, Ill. business registry data+Yellowpages database).

As a search/corrective solution not beholden to the requirements of the postal authority, the cascaded AMEs may also enable loose searches for which to compare the address input against. For example, USPS CASS certification rules restrict both phonetic and string comparisons to very conservative levels that may be utilized during the address coding process. However, in accord with the examples herein, the Processor 140 may employ AMEs with loosened phonetic and string search thresholds to enable its corrective/search capacity.

Of course, those skilled in the art will recognize that various other techniques, modules, procedures and tools for enabling advanced corrective capability—beyond those presented above—may be employed. Ultimately, Processor 140 may engage multiple address correction tools and devices for enabling a postal authority approved result (e.g., certification or validation); particularly, in instances where traditional address quality processing methods fail. After the input address is processed, the verified corrected address is compiled by Compiler 150, and ultimately output as part of an Output Mailing List 104.

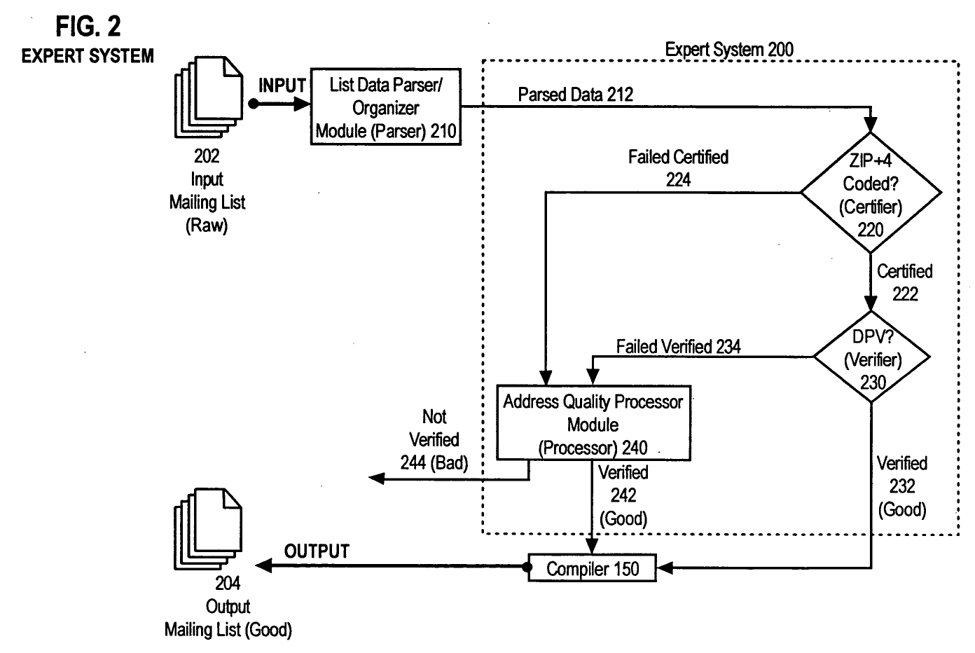

FIG. 2 is an exemplary flowchart depicting the high level process for performing address quality processing. FIG. 2 illustrates Input Mailing List 202 entering Parser 210. Parser 210 transmits parsed data 212 into Expert System 200.

Expert System 200 processes the input addresses and outputs three address data paths: Not Verified 244 (Bad), Verified 242 (Good), and Verified 232 (Good). Not Verified 244 includes a) input address that failed certification (and never attempted verification), and also includes b) input addresses that passed certification but failed verification. Thus, the term “not verified” means failed certification or failed verification. The two paths Verified 242 (Good), and Verified 232 (Good) may be merged before leaving Expert System 200, but are shown as separate paths for emphasis. The first path, Verified 242 (Good), contains corrected addresses. In contrast, the second path, Verified 232 (Good), contains input addresses that were certified and also verified, and have not been corrected by Processor 240.

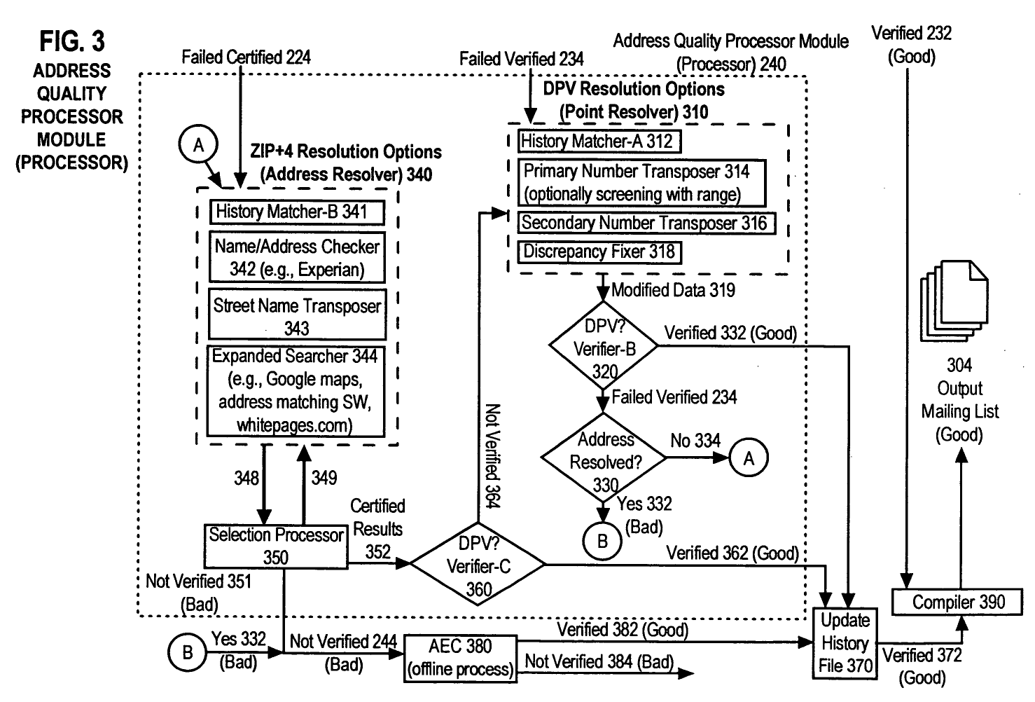

There are two distinct paths flowing into Processor 240. The first path is Failed Certified 224. This path contains input addresses that failed certification by Certifier 220. In contrast, Failed Verified 234 contains input addresses that were certified by Certifier 220, were transmitted to Verifier 230 via path Certified 222, and then failed verification by Verifier 230. Thus, Failed Certified 224 represents an initial or coarse failure by the input address, and Failed Verified 234 represents a second or point failure by the input address. This distinction is key. The failed addresses in Failed Certified 224 are very different from (and probably have much more serious errors than) the failed addresses in Failed Verified 234. Thus, in one embodiment of the present invention, as shown in FIG. 3 below, these distinct types of failures are treated very differently by Processor 240.

For example, the input address (Lewis Latimer, 3501 Devonshire, Germantown, Tenn. 38139) may contain the following address elements: name Lewis Latimer, primary address number 3501, street name Devonshire, city Germantown, state Tenn., and 5 digit ZIP Code 38139. Two distinct error resolution paths may be pursued by processor 240 depending on which type of failure occurs. It will be seen however, from further discussion of the examples herein, that the techniques employed for achieving a viable address quality result respective to one error resolution path may also be utilized for the other. In other words, there may be cross-linking or feedback among the distinct error resolution paths.

FIG. 3 is an exemplary flowchart depicting an address quality processor comprising an address resolver and a point resolver. As discussed above in FIG. 2, two distinct paths flow into Processor 240: the first path is Failed Certified 224, and the second path is Failed Verified 234. Four paths flow out of Processor 240: Not Verified 244, an optional offline path Yes 332 (aka Circled B), Verified 362 and Verified 322.

Note that Not Verified 244 and Yes 332 leave Processor 240, and are combined at the bottom left of FIG. 3 to form Not Verified 244 as shown in FIG. 2. These two paths may be combined inside of Processor 240.

Note that Verified 322 and Verified 362 are equivalent to the single path Verified 242 shown in FIG. 2, but are shown as 2 paths in FIG. 3 to illustrate greater detail. These two paths may be combined inside of Processor 240.

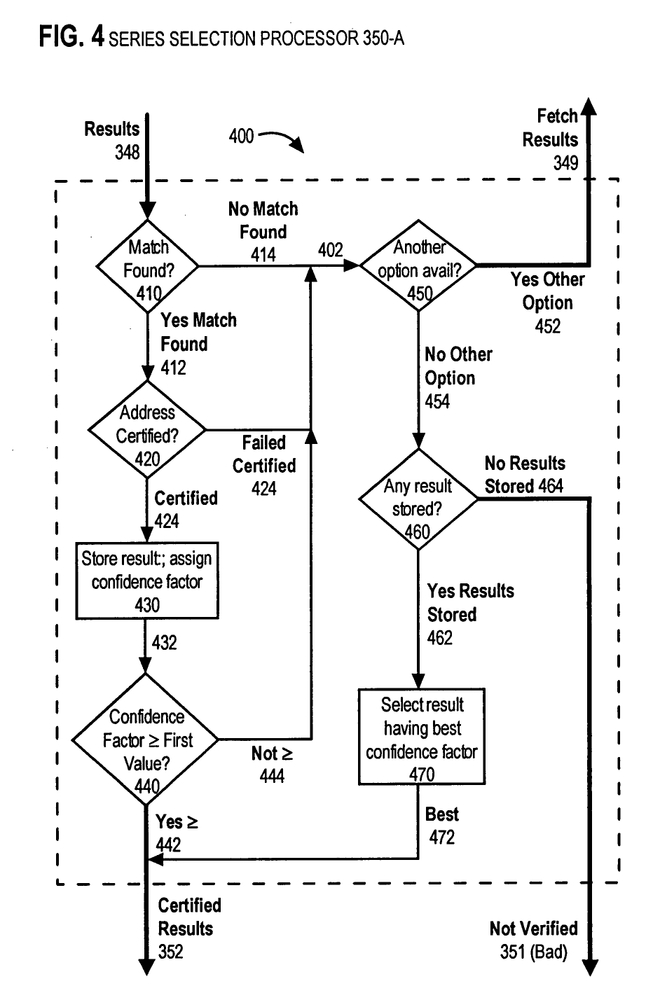

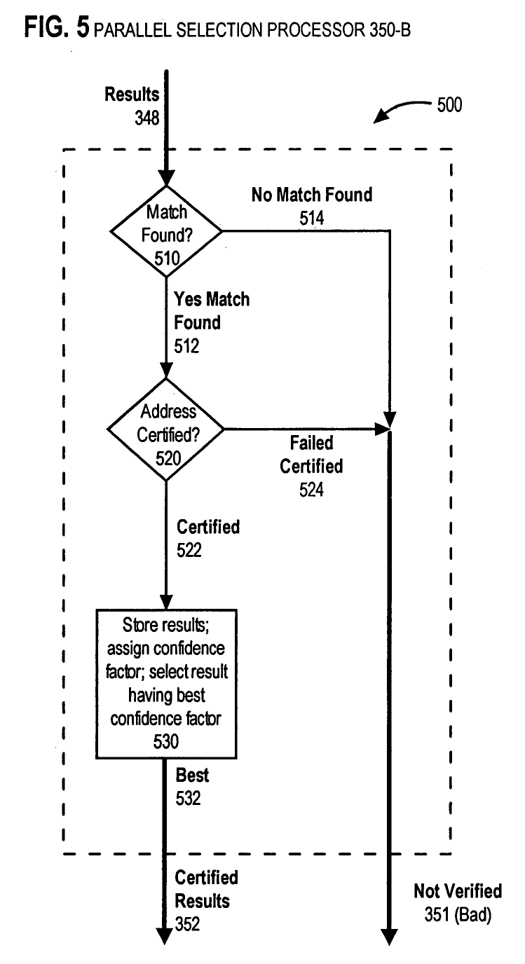

Processor 240 comprises three major modules: a first module labeled ZIP+4 Resolution Options (Address Resolver) 340, a second module labeled DPV Resolution Options (Point Resolver) 310, and Selection Processor 340. Selection Processor 350 is exemplified in FIG. 4 in series format, and in FIG. 5 in parallel format.

Processor 240 also comprises minor modules: Verifier-B 320, Verifier-C 360, Address Resolved? 330. Verifier-B 320 and Verifier-C 360 perform the same function as Verifier 230 in FIG. 2. Typically, software may contain a single module with the verification instructions, and each verifier module shown in the figures would call the single module with the verification instructions. Multiple modules serving the same function are shown in this flowchart to reduce the complexity of the paths. In other words, a single module may perform the verification function for all of the modules shown. Alternatively, Processing Module 240 may invoke the necessary function calls to module Verifier 230 in FIG. 2 or Verifier-B 320 and Verifier-C 360 in instances where said modules are physically located at and controlled by a third party.

The module Address Resolved? 330 determines whether an address has previously passed through Address Resolver 340. The circled A at the bottom right indicates that path No 334 loops to the top of Address Resolver 340. The circled B at the bottom right indicates that path Yes 332 jumps to the bottom left of FIG. 3.

AEC 380 is an Address Element Correction. This is an offline procedure requiring human intervention, typically by postal authority employees. The postal authority may use telephone books, or may use “field knowledge” (ask the human postal carriers), or use other techniques to attempt to match a verified address with the input address. Input addresses sent to AEC 380 have not been verified, despite the efforts of Processor 240. Alternatively, these input addresses that have not been verified may be sent to a third party along with associated transaction records, or placed in a report. Offline procedures are inherently slow and expensive.

Update History File 370 uses resolved (or corrected) address that have been verified and associates the verified address with the initial input address in a history file or database for use with History Matcher-A 312 and/or History Matcher-B 341. As previously discussed regarding verifier modules, the history matcher modules may be a single module, or may be two distinct modules. If two distinct history matcher modules are used, it may be convenient to share a single history file database. Update History File 370 may be built into a History Matcher module, but it is convenient to show Update History File 370 outside of Processor 240 in order to indicate that processing by the Processor 240 is effectively finished, and in order to indicate that other resolved and verified addresses from other sources such as AEC 380 may also be used to update a History File. The History File may be stored in More Storage 167 in FIG. 1, and may be accessed by the History Matcher(s) as needed. Only previously unresolved addresses need be updated.

Compiler 390 compiles verified input addresses from path Verified 232 and verified resolved addresses from path Verified 372. Compiler 390 outputs Output Mailing List 304. Compiler 390 may divide the Output Mailing List into two distinct lists, and the two distinct lists may qualify for different treatments such as different levels of discount from the postal authority. The Compiler may output an associated confidence level with each address. For example, resolved addresses from path Failed Certified 224 may have a different confidence level than from Failed Verified 234. Additionally, or alternatively, Address Resolver 340 or Selection Processor 350 or Point Resolver 310 may assign confidence values. Distinct confidence levels may receive distinct discounts from a postal authority based on predictive or historic levels of successful delivery. Additionally, third parties users may wish to send expensive color brochures to high confidence resolved addresses, in contrast to black and white brochures to low confidence resolved addresses. In other words, a confidence value associated with an address is valuable data which may be used or sold.

Address Resolver 340 may comprise multiple modules such as History Matcher-B 340, Name/Address Checker 342, Street Name Transposer 343, and Expanded Searcher 344. These multiple modules may be operated in series or on parallel, as will be discussed in more detail in FIG. 4 and FIG. 5, or in some combination of series and parallel.

Address Resolver 340 receives Failed Certified 224, and outputs via path 348 to Selection Processor 350. Address Resolver 340 may also receive input 349 from Selection Processor 350, as will be discussed in more detail in FIG. 4 and FIG. 5.

Point Resolver 310 may comprise multiple modules such as History Matcher-A, Primary Number Transposer 314, Secondary Number 318, and Discrepancy Fixer 318. Primary Number Transposer 314, Secondary Number 318, and Street Name Transposer 343 (from Address Resolver 340) may be portions of a single large Transposer module (not shown), or alternatively may share submodules (e.g. a submodule for transposing digits of three digit numbers). Point Resolver 310 receives Failed Verified 234, and outputs Modified Data 319. Point Resolver also receives Not Verified 364 from Verifier-C 360.

Point Resolver 310 is configured to perform relatively quick and easy resolutions to Failed Verified 234, because input address in path Failed Verified 234 have already been certified by Certifier 220 in FIG. 2, and thus may be relatively high quality input addresses with relatively minor errors.

Example for Failed Verified 234 and Point Resolver 340

As an example, the input address may be: Lewis Latimer, 3501 Devonshire, Germantown Tenn. 38139. This input address has been successfully ZIP+4 coded or certified by Certifier 220 because the primary number falls within a range of numbers associated with the other address elements. However, this input address has failed Verifier 230 because the primary number (3501) does not correspond to a specific postal authority recognized delivery point. Thus, the status of this input address may be described using USPS terminology as: CASS ZIP+4 code return, and DPV failure.

As a first step, Point Resolver 310 preferably would use History Matcher-A 312 to check for a resolved and verified address associated with the identical input address in a history file or database. If a successful match is found, Point Resolver 310 may output the historical resolved and verified address to Verifier-B 320, and perform an update verification. If the update verification was successful, then Verifier-B 320 would output the resolved verified address through 322. Alternatively, a successful history match may skip Verifier-B 320, and output directly (not shown), particularly if the history file had a recent date associated with the history data (fresh data). The other modules inside of Point Resolver 310 will be addressed sequentially.

If History Matcher-A 312 fails to find a match, then Primary Number Transposer 314 may generate one or more proposed resolved addresses as output in path Modified Data 319 for verification. Primary number (street number) transposition has previously been discussed. However, input addresses from the Failed Verified 234 may be associated with range data because these addresses have been certified by Certifier 220. For example, an address of 123 Main Street may have been certified as being in the associated range of 100 to 199 which is associated with the other address data. Thus, transpositions such as ‘321’ and ‘213’ which fall outside of the certified range may be screened out and not considered further. This type of range screening is novel. Transpositions such as 132 which fall within the associated range may be output for attempted verification. Note that multiple transpositions which fall within the associated range may be output simultaneously to the verifier. The verifier may use various factors to determine the best transposition from among multiple verified transpositions. For example, the verifier may access Name/Address Checker 342 and check if either of the multiple verified transpositions matches an address from Experian® which is associated with the same name.

Note that resolved addresses from path Not Verified 364 may also contain range data, because these resolved addresses have been certified inside Selection Processor 350, as shown in FIGS. 4 and 5.

If no primary number transpositions appear attractive, then, optionally, Secondary Number Transposer 316 may be used to transpose apartment numbers or suite numbers. Presently secondary number data is not used in the USPS Certifier and Verifier. However, such secondary number data may be used as an additional quality tool whenever it becomes available.

Finally, Discrepancy Fixer 318 may be used to generate resolved addresses which are output to Verifier-B 320.

Note that more complex algorithms similar to Selection Processor 350 may be used in cooperation with Point Resolver 310. For example, the modules in Point Resolver 310 may be used in a parallel fashion, similar to FIG. 5. Alternatively, the modules in Point Resolver 310 may be used in serial fashion, similar to FIG. 4.

Additionally, the resolved addresses in path Modified Data 319 may be associated with and be transmitted with additional related data such as a confidence level or tracking data recording how the resolved address was generated. This associated data may follow the resolved addresses all the way to Output Mailing List 304.

If Verifier-B fails to verify the resolved address (or addresses) from Point Resolver 310, then Address Resolved? 330 determines whether the input address (that generated the resolved address) has been previously processed by Address Resolver 340. If the input address has previously passed through Address Resolver 340, then Processor 240 gives up, and outputs the Failed Verified input address to Circle B. In this example, Circle B jumps to the bottom left of FIG. 3, where it merges with Not Verified 351 and then flows to AEC 380 as previously discussed. As Circle B is an optional path, the Processor may optionally generate a message to the user interface displayed by Monitor 166 indicating that no resolution was attainable for the specific address.

Example for Failed Certified 224 and Address Resolver 340

As previously discussed, input addresses in Failed Certified 224 have failed certification at Certifier 220 in FIG. 2. Thus, no certified ZIP+4 code is associated with the input address. Thus, these input addresses in Failed Certified 224 are generally of a lower quality than the input addresses in Failed Verified 234 which have been certified, and have a certified ZIP+4 code associated with the input address. Because of this general low quality of input addresses in Failed Certified 224, Address Resolver 340 is more complex and more robust and farther reaching that Point Resolver 310.

Address Resolver 340 preferably begins by using History Matcher-B 341, similarly to History Matcher-A 312 in Point Resolver 310. If History Matcher-B 341 fails to find a match, then the other Address Resolver 340 modules may be used sequentially or serially, in cooperation with (or interaction with) Selection Processor 350. This cooperation with Selection Processor 350 will be discussed in greater detail in FIG. 4 and FIG. 5.

Additionally, note that Address Resolver 340 also receives addresses from Circle A, from Point Resolver 310. These addresses from Circle A include addresses from Failed Verified 234, and optionally include associated resolved addresses from Point Resolver 310 that failed verification, but may still prove useful as starting points for secondary or broader searches using the Address Resolver.

Selection Processor 350 is discussed in detail below with respect to FIG. 4 and FIG. 5.

FIG. 4 illustrates an exemplary series selection processor. Series Selection Processor 350-A receives results from Address Resolver 340 via path Results 348. These results initially contain the results of History Matcher-B 341. As previously discussed regarding Point Resolver 310, a history match may be treated as a best result, and may be outputted immediately without even verifying.

### EXAMPLE A

Decision diamond 410 determines if a matched address was found. If a match was found, then path Yes Match Found 412 transmits the matched address (or resolved address, or corrected address, or proposed address) to decision diamond 420. Decision diamond 420 checks if the match has previously been certified (for example, the match originated from a certified address database), or alternatively attempts to certify the match. In the latter case, the Yes Match Found 412 address—a potential candidate to facilitate resolution—is tested against postal authority approved address data even though the address itself may have been generated using address data not approved by the postal authority. If the match is certified, then box 430 stores the result (the match), and assigns a confidence factor to the result. Optionally, if the confidence factor of the stored result is equal to some predetermined first value (relatively high), then Series Selection Processor 350-A outputs the stored result via path Yes≧442 which merges with path Best 472 and exits as path Certified Results 352.

The confidence level assigned may be based on multiple factors, including but not limited to: similarity of the match/candidate to the original input address, the date of information used for resolving address errors, the number of corrections required to resolve potential errors (e.g., the number of alphanumeric deletions or additions required), the number of text string matches, etc. The confidence level may be determined by the specific option module performing the match (such as Street Name Transposer 343), or determined by the Address Resolver 340, or Point Resolver 310, or determined at a higher level by Processor 240. Generally, a history match should be assigned the highest confidence level.

### EXAMPLE B

Decision diamond 410 determines if a match was found. If no match was found, then path 414 leads to decision diamond 450 which determines if another resolution option is available. If another resolution option is available (for example, Name/Address Checker 342), then Series Selection Processor 350-A notifies Address Resolver 340 via Fetch Results 349 to try the next option or module in a sequential, or alternatively, predetermined order. If no other options are available, then path No Other Option 454 leads to decision diamond 460 which determines if any results are stored. Stored results are resolved addresses that have been certified and assigned a confidence factor. If there is at least one stored result, then decision diamond 460 outputs the stored results to box 470 via path Yes Results Stored 462. Box 470 selects the result with the best (highest) confidence factor, and outputs the best result via path Best 472 to merge with path Yes≧442 and exits as path Certified Results 352.

The above Example A and Example B illustrate all of the decision diamonds and boxes of Series Selection Processor 350-A. Of course, many other paths and combinations of paths are possible, and are evident from the flowchart to a person of ordinary skill in the art.

Additionally (not shown), Box 470 may require that the best result have a confidence factor equal to or greater than some second value which is less than the first value, and is considered a minimum value for additional processing. A best result with a confidence factor below the second value may be output (not shown) to the Not Verified 351 path in order to terminate processing by Processor 240.

FIG. 5 illustrates an exemplary parallel selection processor. Parallel Selection Processor 350-B receives results from Address Resolver 340 via path Results 348. These results may initially contain the results of History Matcher-B 341. As previously discussed regarding Point Resolver 310, a history match may be treated as a best result, and may be outputted immediately without even verifying. Thus, the parallel selection processing of Parallel Selection Processor 350-B may be preceded by history matching, and may not parallel process if a history match is found and certified. Alternatively, all of the modules of Parallel Selection Processor 350-B may parallel process an input address from Failed Certified 224, or an input address (and optionally associated point resolved addresses) that have failed verification from Point Resolver 310 via Circle A.

### EXAMPLE C

Parallel Selection Processor 350-B receives all results from Address Resolver 340 via path Results 348. Decision diamond 510 determines whether any matches have been found. If at least one match has been found by any module in Address Resolver 340, then the at least one match is transmitted via path Yes Match Found 512 to decision diamond 520. Decision diamond 520 determines whether the match has already been certified, or passes certification now. In the latter case, the Yes Match Found 512 address—a potential candidate to facilitate resolution—is tested against postal authority approved address data even though the address itself may have been generated using address data not approved by the postal authority. If the match has already been certified or passes certification now, then decision diamond 520 passes the certified match to Box 530. Box 530 stores the results, assigns a confidence factor, and selects the result having the best confidence factor. Box 530 outputs the result having the best confidence factor via path Best 532 which is equivalent to path Certified Results 352 as it exits Parallel Selection Processor 350-B.

Additionally, if there are multiple identical results (duplicate results) that were derived by different modules, then the confidence factor of the result may be increased. Further, redundant results may be eliminated.

Example C illustrates all of the decision diamonds and boxes of Parallel Selection Processor 350-B. Of course, many other paths and combinations of paths are possible, and are evident from the flowchart to a person of ordinary skill in the art.

Optionally, Box 530 may require some minimum confidence level (not shown) to output a best or certified result. If the minimum confidence level is not satisfied, then Box 530 may route the input address to path Not Verified 351.

Further, Parallel Selection Processor 350-B may operate in more complex modes. For example, Address Resolver 340 may operate in parallel, but may output results as soon as they are obtained. This process may be described as parallel processing combined with opportunistic outputting. Simultaneously, Parallel Selection Processor 350-B may process the opportunistic outputs serially as they arrive, and serially testing to see if any result has a confidence factor≧a first value, wherein the first value is a relatively high value. Upon determining that a result has confidence factor≧a first value, the Parallel Selection Processor 350-B may output the result, and may shut down or preemptively terminate any Address Resolver 340 modules that are still resolving. In this fashion, Parallel Selection Processor 350-B may effectively self-terminate immediately after a single relatively high confidence factor result is obtained.

Optionally, Parallel Selection Processor 350-B may monitor time spent or expenses accrued by the modules in Address Resolver 340, and may stop Address Resolver 340 when some maximum amount of time or expenses is met or exceeded, and may select the received result having the best confidence factor after stopping the Address Resolver. Similarly, Series Selection Processor 350-B may also monitor time or expenses accrued by the modules in Point Resolver 310, and may stop Point Resolver 310.

Optionally, Parallel Selection Processor 350-B may output multiple certified results, and not merely the best result. In this fashion, Verifier-C 360 has a greater chance to verify at least one result, and Verifier-C 360 may select and output the verified result with the highest confidence factor.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Specifically, while the preceding discussion respective to address quality processing is generally discussed in terms of the USPS, skilled artisans will recognize that the exemplary concepts presented are not restricted to any one postal authority. Furthermore, those skilled in the art will recognize that the examples presented herein may be employed in various types of processing environments, and in connection with different system architectures. The examples presented herein may be employed in any environment or in connection with any system where address quality and resolution is an imperative. This includes, but is not limited to, sorting environments and systems, data center processing environments and systems, multi-line optical character reading (MLOCR) environments, list processing systems, network based mail processing systems, address quality processing software systems, micro computing devices, mainframe systems, etc.

What is claimed is:

1. A method for processing input addresses comprising:
a) receiving input addresses;
b) address resolving one or more of the received input addresses using an address resolver, wherein the address resolver comprises one or more address resolution elements for rendering an address capable of certification, and wherein at least one of said resolution elements is not approved by a postal authority for certification; and
c) selection processing the address resolved, received input addresses using a selection processor, wherein the selection processor comprises a certifier approved by a postal authority for certification.

2. The method of claim 1 further comprising:
a) verifying the selection processed, address resolved, received input addresses using a verifier; and
b) outputting all verified, selection processed, address resolved, received, input addresses.

3. The method of claim 1 wherein the address resolver includes one or more of: a history matcher, a name/address checker, a street name transposer and an expanded searcher.

4. The method of claim 1 wherein the input addresses consist only of addresses that have failed certification, or have failed verification, or have failed certification and failed verification.

5. The method of claim 1 wherein the address resolver first uses a history matcher, and outputs any history matched result.

6. The method of claim 5 wherein the address resolver, upon a failure by the history matcher, further uses a name/address checker or an expanded searcher.

7. The method of claim 1 wherein the address resolver further comprises a street name transposer.

8. The method of claim 1 wherein the address resolver and the selection processor interact serially until an address resolved address meeting a predetermined confidence level is found, or until every address resolution element in the address resolver has been used.

9. The method of claim 1 wherein the address resolver and the selection processor interact in parallel, and the selection processor selects the address resolved address with the highest confidence level that at least meets a predetermined confidence level.

10. The method of claim 1 further comprising the step of outputting all failed verified, received, input addresses to a point resolver.

11. A method for processing input addresses comprising:
a) receiving input addresses;
b) point resolving the received input addresses using a point resolver, wherein the point resolver comprises one or more point resolution elements for rendering an address capable of verification, and wherein at least one of said point resolution elements is not approved by a postal authority for verification;
c) verifying the point resolved, received, input addresses using a verifier approved by a postal authority for verification; and
d) outputting all verified, point resolved, received, input addresses.

12. The method of claim 11 wherein the point resolver comprises one or more of: a history matcher, a primary number transposer, and a discrepancy fixer.

13. The method of claim 12 wherein the point resolver first uses the history matcher, and outputs any history matched result.

14. The method of claim 12 wherein the point resolver, upon a failure by the history matcher, uses the primary number transposer.

15. The method of claim 14 wherein the primary number transposer utilizes a range from a certifier to screen transposition results before sending screened transposition results to a verifier.

16. The method of claim 15 wherein the point resolver further comprises a secondary number transposer.

17. The method of claim 11 further comprising the step of outputting at least some failed verified, received, input addresses to an address resolver.

18. A method for resolving address data comprising the steps of:
a) receiving address data input not meeting one or more postal authority standards;
b) processing the address data input using one or more resources, said resources including at least:
i) a first data source comprising address data not approved by a postal authority;
ii) a second data source comprising address data approved by a postal authority; and
iii) one or more software processing modules for processing the first and second data source, said first data source being usable by at least one of the software processing modules in association with the address data input for rendering address data output capable of meeting postal authority standards, said second data source being usable by at least one of the software processing modules for determining whether or not the address data output is sufficient to meet postal authority standards; and
c) outputting the address data output determined to be sufficient to meet postal authority standards.

19. The method of claim 18 wherein the one or more software processing modules includes one or more of a history matcher, a name/address checker, a street name transposer, an expanded searcher, a selection processor, a primary number transposer, a secondary number transposer and a discrepancy fixer.

20. The method of claim 18 wherein the one or more software processing modules further includes one or more of a certifier and a verifier.

21. A method for resolving address quality processing errors comprising the steps of:
a) receiving an initial address;
b) determining that a specific numeric portion of an address element of the received initial address is within a certifiable range in accordance with certification data from a postal mailing authority;
c) determining that the initial address does not correspond to a verified delivery point address according to verification data from the postal mailing authority;
d) performing transposition logic processing on the numeric portion, the transposition logic being performed on the basis of the certifiable range in order to generate at least an output address; and
e) determining whether the output address corresponds to a verified delivery point address.

22. The method of claim 21 wherein the numeric portion of the address is at least one or more of a primary address number, a suite number or an apartment number.
